(19) United States
(12) Patent Application Publication
(10) Pub. No.: US 2007/0209856 A1
(43) Pub. Date: Sep. 13, 2007

(54) Assistant Propulsion Mechanism for Vehicle

(76) Inventor: Yong Bin WEI, Tainan City (TW)

Correspondence Address: BANGER SHIA, 204 CANYON CREEK, VICTORIA, TX, 77901, US

(21) Appl. No.: 11/683,545

(22) Filed: Mar. 8, 2007

(30) Foreign Application Priority Data
Mar. 9, 2006 (TW) 095107881

(51) Int. Cl. B60K 17/00

(52) U.S. Cl. 180/305

(57) ABSTRACT

This invention relates to an assistant propulsion mechanism for vehicle wherein grooves are made at side edge of tire, wheel and silicon plate of stator are tightened, silicon plate of stator is equipped with copper wires and magnets; axis is fixed at wheel, rotor turntable is covered onto axis, besides, rotor turntable is installed with magnets which are assembled in opposite to same pole of magnet of silicon plate of stator; mini gear wheel is installed on axis of gear wheel to mesh with gear wheel of rotor turntable, meanwhile, gear turntable is also equipped with eccentric shaft eccentrically; in addition, silicon plate of stator has cylinder of air compressor, and spring, piston and air push sheet are installed inside said cylinder, silent board is also installed in cylinder, air push sheet is pivoted with eccentric shaft; return wheel bar passes through axis to be fixed at center of rotor turntable; two push bars are installed oppositely and pivoted with two ends of return wheel bar respectively; copper wire is connected to charger and battery by conducting wire, therefore, this mechanism can promote propulsion of vehicle, generate power, inflate tire automatically and save gasoline, overall performances of vehicle are improved accordingly.

### FIELD OF THE INVENTION

This invention relates to an assistant propulsion mechanism for vehicle, especially relates to an assistant propulsion mechanism for vehicle to improve the overall performances of vehicle, namely, it can promote propulsion of vehicle, generate power, inflate tire automatically and save gasoline.

### BACKGROUND OF THE INVENTION

Usually, power for vehicle is generated by its propulsion mechanism, wherein propulsion mechanism is powered by gasoline refueled, such as gasoline or diesel oil, such traditional power generation mode consumes more gasoline in higher cost that lags behind nowadays energy-saving economy; meanwhile, propulsion of many parts of vehicle is not properly utilized, for example, turning force produced by tire as vehicle is driving, thus, assistant propulsion mechanism of this invention can reduce gasoline consumption in lower cost that answers to the principle of energy-saving.

### SUMMARY OF THE INVENTION

Object of this invention is to provide an assistant propulsion mechanism for vehicle which can promote propulsion of vehicle, generate power, inflate tire automatically and save gasoline so as to improve the overall performances of vehicle accordingly.

In order to reach above said object, this invention provides an assistant propulsion mechanism for vehicle which features in: groove (1A) is made at side edge of tire (1), screws are made around wheel rim (2) of tire (1), meanwhile, screws are also set on silicon plate of stator (7) and bolt (9) passes through wheel rim (2) and screw of silicon plate of stator (7) to tighten wheel rim (2) and silicon plate of stator (7), and copper wire (6) and magnet (10) are set on silicon plate of stator (7), insulation plate (8) is assembled around copper wire (6); axis (3) is fixed at wheel rim (2) with bolt (4) and through hole (8A) in wheel rim (2), rotor turntable (14) is covered onto axis by through hole (14A), magnet (15) on rotor turntable (14) is set opposite to magnet (10) on silicon plate of stator (7) in same pole; turntable of gear wheel (12) is connected with center of gear wheel (12B), wherein mini gear wheel (12S) is assembled at center of gear wheel (12B) so as to mesh with gear wheel (14B) of rotor turntable (14), besides, eccentric shaft (12A) is also assembled on turntable of gear wheel (12) eccentrically;

Besides, several air compressor cylinders (11) are installed on silicon plate of stator (7), which are fixed at silicon plate of stator (7) with bolts, wherein inlet tube (11A) is installed at one end of cylinder and outlet tube (11B) is at another end, meanwhile, spring (11B1), piston (11B2) and air push sheet (11E) are assembled inside said cylinder (11), board (11B3) with through hole at center is also assembled in cylinder (11), one end of piston (11B2) is connected with spring (11B1) against outlet tube (11B) via through hole of board (11B2); and another end of piston (11B2) is connected with air push sheet (11E) which is pivoted with eccentric shaft (12A) through push bar (11C);

Return wheel bar (16) passes though axis (3) and is fixed at center of rotor turntable (14) by bolt (18), nut (19A) is screwed onto axis to connect wheel rim (2), rotor turntable (14) and return wheel bar (16); two sets of push bars (17) are installed oppositely to pivot with two ends of return wheel bar (16) respectively, and ends of push bar (17) have rubber (17A); one end of spring (19) is connected to middle of push bar (17) and its another end is connected with silicon plate of stator (7); if tire turns, the parts to contact ground are compressed, and push bar (17) and rubber (17A) may be pushed upward if contact ground to drive return wheel bar (16), that consequently drive rotor turntable (14), meanwhile, rotor turntable (14) and silicon plate of stator (7) produce relative turning to generate power, cylinder (11) is also inflated; if push bar does not contact ground, it will be pulled back by spring (19) for resetting; copper wire (6) is connected to charger (32) and battery (31), ammeter (33A) connected with battery (31) displays the left volume;

Two ends of rotor turntable (14) are oppositely equipped with cylinders (22), screw (20) is set in cylinder, and gear wheel (21) is fixed at axis (21A) of screw (20), and gear wheel (21) meshes with gear wheel (14B) of rotor turntable (14), one end of cylinder (22) is installed with inlet tube (23A) and its another end has outlet tube (23B), both tubes are fixed at silicon plate of stator (7) by bolts, and cylinder cover (20A) is also fixed at silicon plate of stator (7) by bolt;

Barrel (1105) is installed with anti-collision device (1104) and fixed at car body (53) by bolt (A), one head of barrel (1105) has an extended tube (1108) which is connected with electromagnetic valve (1106), and electromagnetic valve (1105) is connected to switch on instrument panel through conducting wire (1107), rubber (1109) is installed beside fuel feed hole of vehicle, you only open switch to start electromagnet valve and push away rubber for refueling.

Air in cylinder (11) enter into inlet tube (23A) to inflate tire, then, air flow into outlet tube (23B) and enter into air tank (24) via air tube (23), control valve is installed between air tube (23) and air tank (24), so that said control valve could turn off if tire is flat; to cool down air tank (24) with electric control board, and air tank is connected to air gauge (33) by air tube to display pressure of air tank (24); air tube (23) and air tank (24) are connected to tube (1102) which is installed with wind wheel (1101), and wind wheel (1105) is connected to axis of motor (110) which is then connected with gear wheel (119) to drive gear wheel (118) of turntable, and gear wheel (118) is connected with axis (118D) of wind wheel (118), meanwhile, wind wheel (118B) is also installed with box (118A) and seat (118Y);

Air tube (23) is connected to electronic valve (25), thus, air entering can cool it down first, then connected to cylinder (34) of engine; bushing (S) is fixed at air tube (23) by bolt (S1); electronic valve (22) is passable to cylinder (34) of engine, air tube (23), wind tube (118A) and inlet tube (23A); fixing turntable (1103) is installed under engine and its gear wheel (117) meshes with gear wheel (116) to drive axis of seat (115), gear wheel (116) meshes with mini gear wheel (113), axis (112) is fixed at mini gear wheel (113) and mini gear wheel (111) is fixed at axis (112), mini gear wheel (111) meshes with gear wheel (29) of engine;

Gasoline throttle (37A) is connected to power-on point (36) to start motor and electronic valve; spring is assembled at back of gasoline valve (37A), so that it will no be powered if not refueled; motor (44) is switched on/off accordingly;

Steering button (37B) to control speeds of vehicle is also installed, and row teeth bar under gasoline throttle is connected to steering button (37B) to control speeds of vehicle, thus, the lower gasoline throttle is stepped, the faster the speed is, however, if step off, power is cut off.

If vehicle is not driven, circuit may inform electronic valve (25) to turn off.

Groove (1A) is made at rim of tire (1), end of push bar (17) is matched to groove (1A) of tire (1), push bar (17) moves upward/downward to generate power and inflate tire.

Mini gear wheel (111) meshes with gear wheel (29) of engine, return wheel bar (16) drives rotor turntable that can produce powerful power.

Magnet installed around belt wheel of engine generates power with stator that can release rotor and save space.

Electronic valve is connected to moving sheet of cylinder of engines through air tube, if moving sheet is on the top, electronic valve (22) turns off and electronic valve (25) turns on, air entering into cylinder press moving sheet downward.

If moving sheet is installed beneath, electronic valve (22) turns on and electronic valve (25) turns off, air is exhausted of cylinder to enter into wind wheel through air tube to drive mini gear wheel.

Air tank (24) is the passable windbag of air power and it is also used for anti-collision.

Screw (20) runs stably without noise, return wheel bar (16) drives rotor turntable (14) to generate power and inflate tire.

Push bar (11C) moves forward/backward along with air push sheet (11E) at the same time so that vehicle wheels drive smoothly.

Two sets of push bar (17) are installed oppositely and run stably. Magnet (48) is installed under car body (53), magnet (47) is also laid down along road (47A), same pole of these two magnets are laid down oppositely so as to exclude each other that seems weight of vehicle is reduced, so, vehicle may consume fewer gasoline and power.

Solar cell (49) is installed on car body (53), transparent basket (50) and copper wire (55) are installed in it, wherein basket (50) and solar cell (49) are fixed at car body (53) by bolt (52).

Circuit (43) is to turn on/off electronic valve, and circuit (44) is to control motor.

Silent sheet is installed in cylinder (11) so as to prevent air push sheet (11E) from producing noise.

All fixing connections are connected with bolts.

Push bar and switch are installed onto engine, push bar touches switch to power on as engine is running so as to push forward moving sheet to produce power.

Rotor and stator of cylinder are fixed under shoes and foot of human body, which are connected to charger for charging and inflating as human body is walking.

### BRIEF DESCRIPTIONS OF DRAWINGS

FIG. 1 is the exploded view of two sections of air compressor generating stator;

FIG. 2 is the combination view of two sections of air compressor generating stator;

FIG. 3 is the combination view of screw bar;

FIG. 4 is the combination view of push bar and return wheel bar in wheel hub;

FIG. 5 is the combination view (car combination view of solar cell) that magnet excludes car;

FIG. 6 is the combination view that circuit turns on/off electronic valve and switches on/off motor;

FIG. 7 is the descriptions of air supply system, motor, electronic valve and gear wheel;

FIG. 8 is the combination view to turn on/off electronic valve;

FIG. 9 is the combination view of finished products of vehicle such as generation system, air supply system, electronic valve, rebirth energy equipment;

FIG. 10 is the combination view of motor (including double-duty engine);

FIG. 11 is the combination view of small-sized pedal generator and charger.

### DETAILED DESCRIPTIONS OF THE PREFERRED EMBODIMENTS

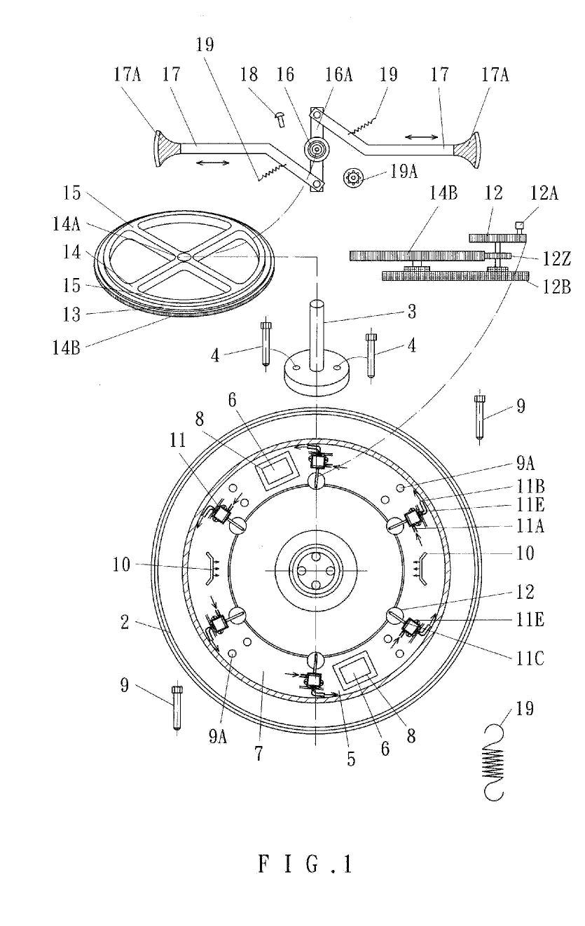

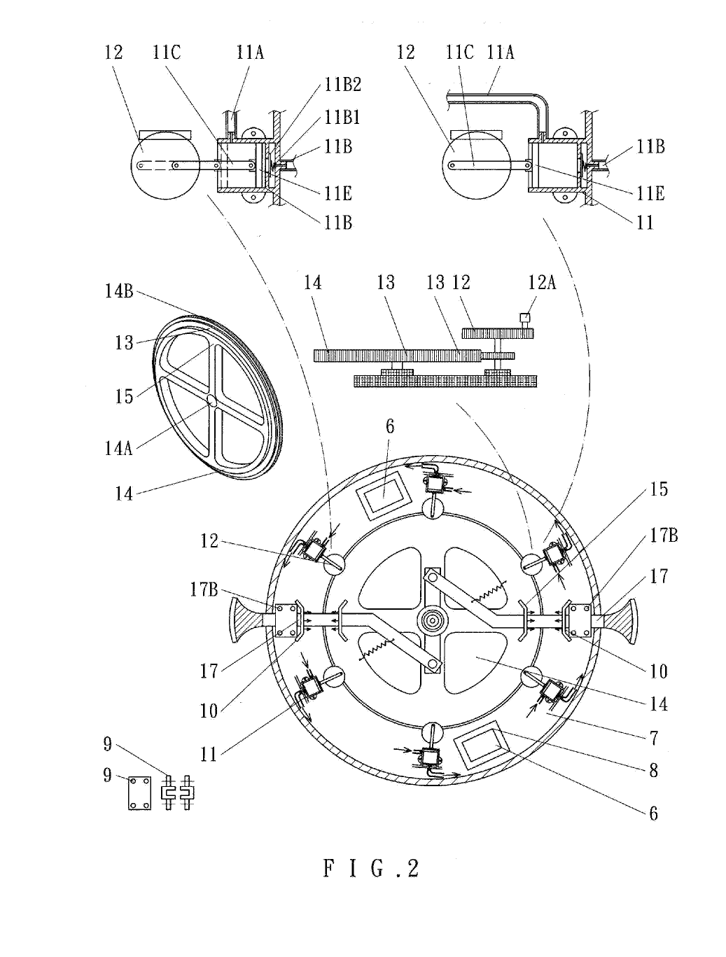

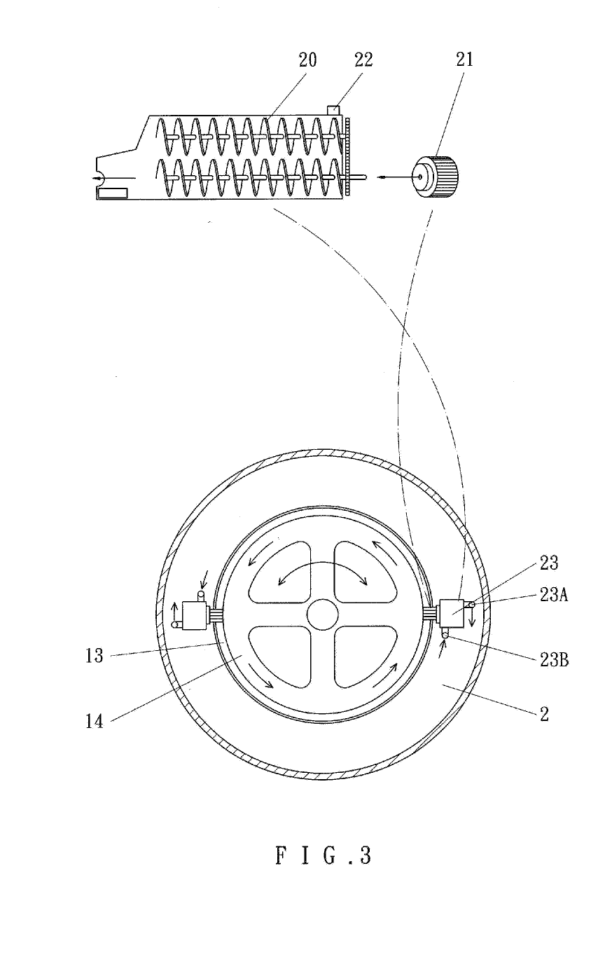

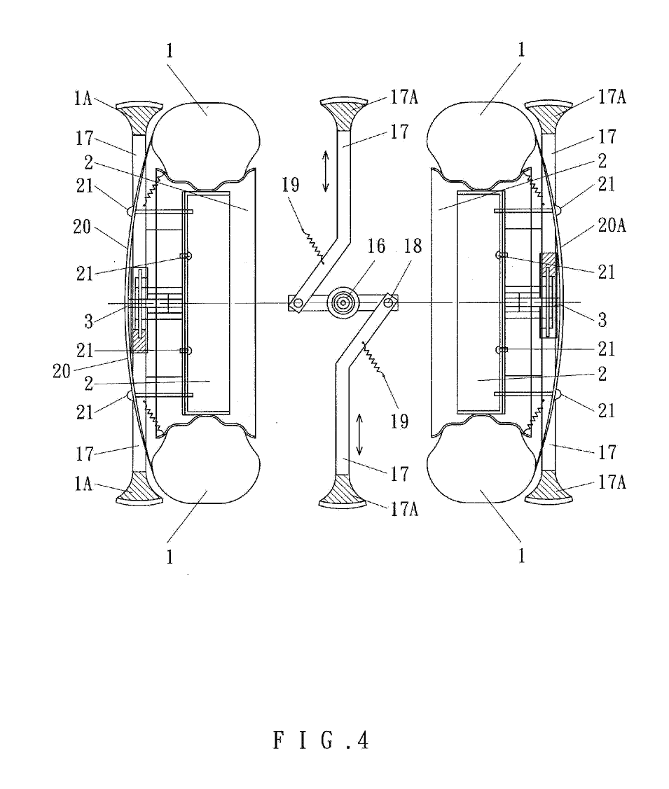

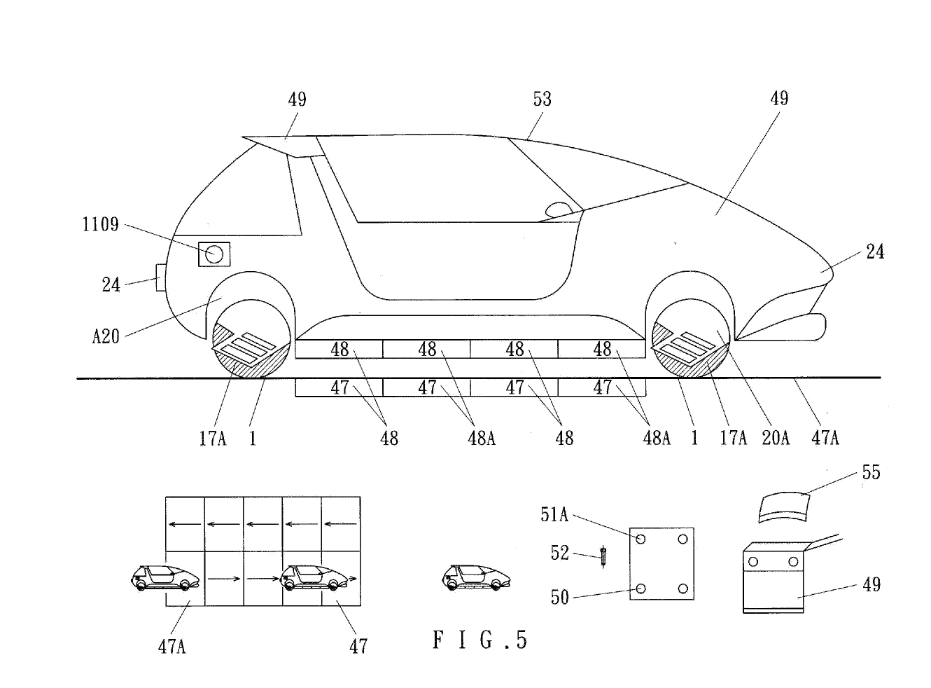

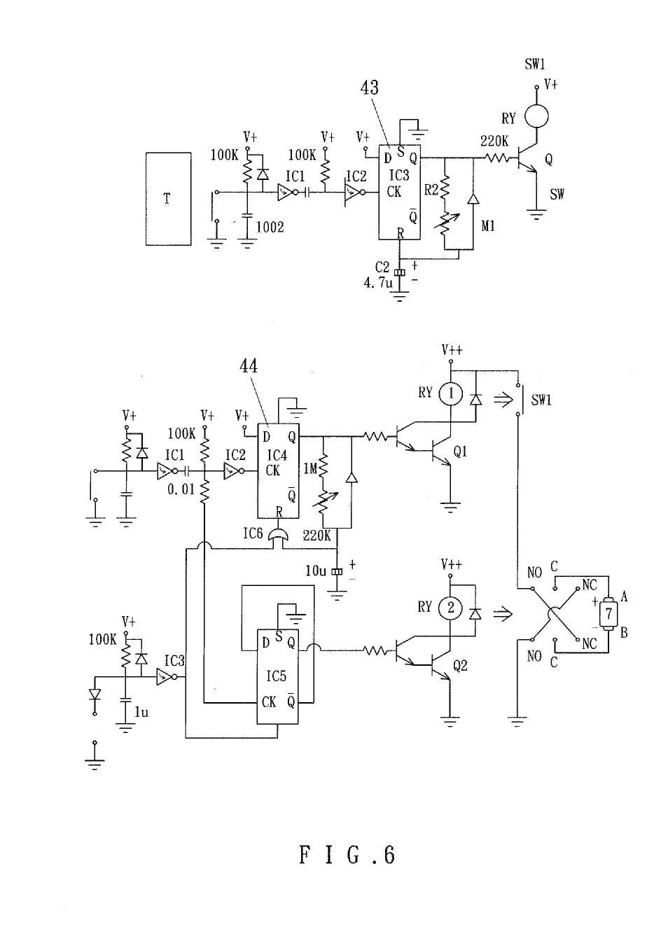

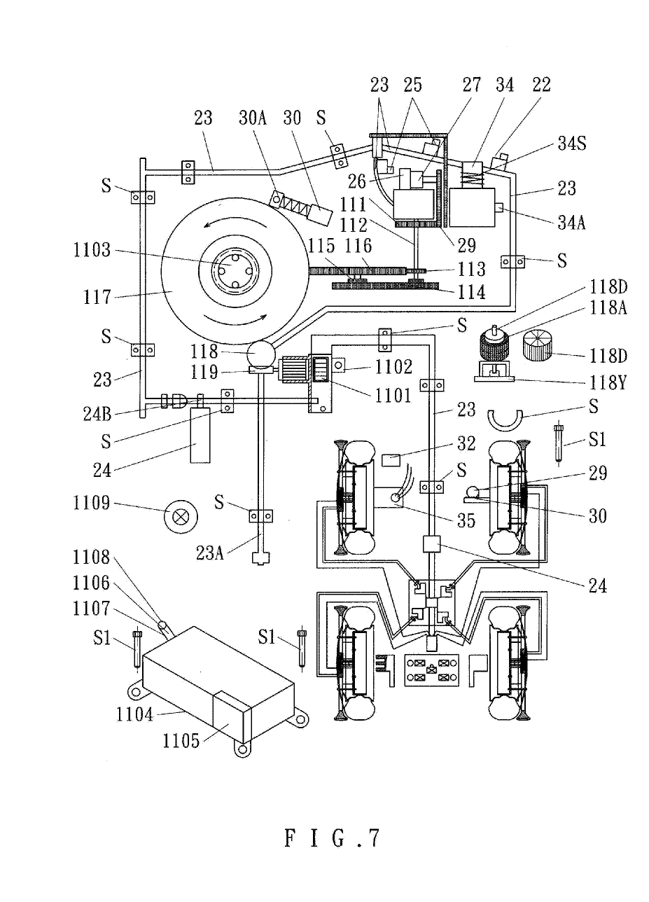

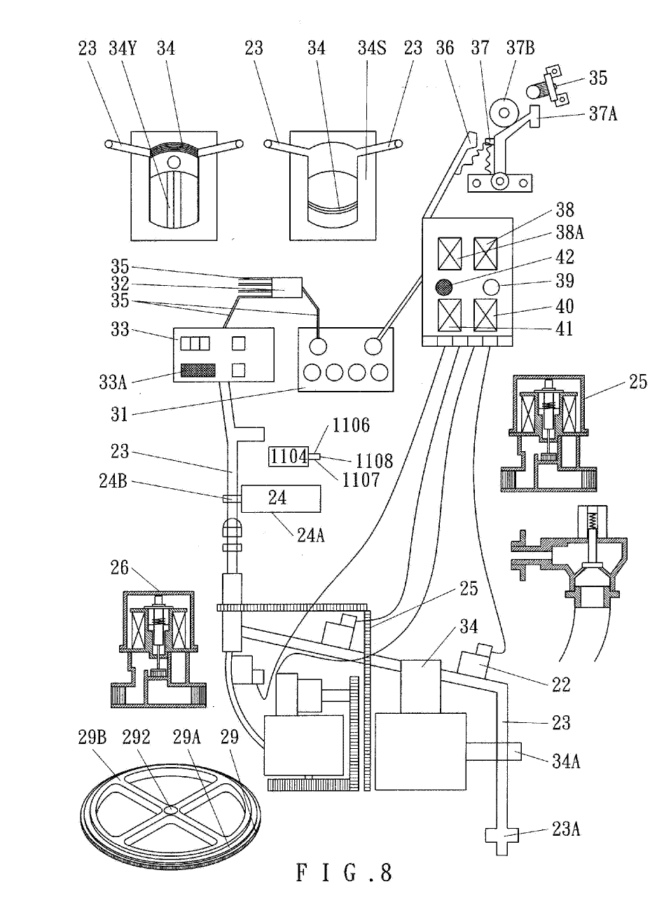

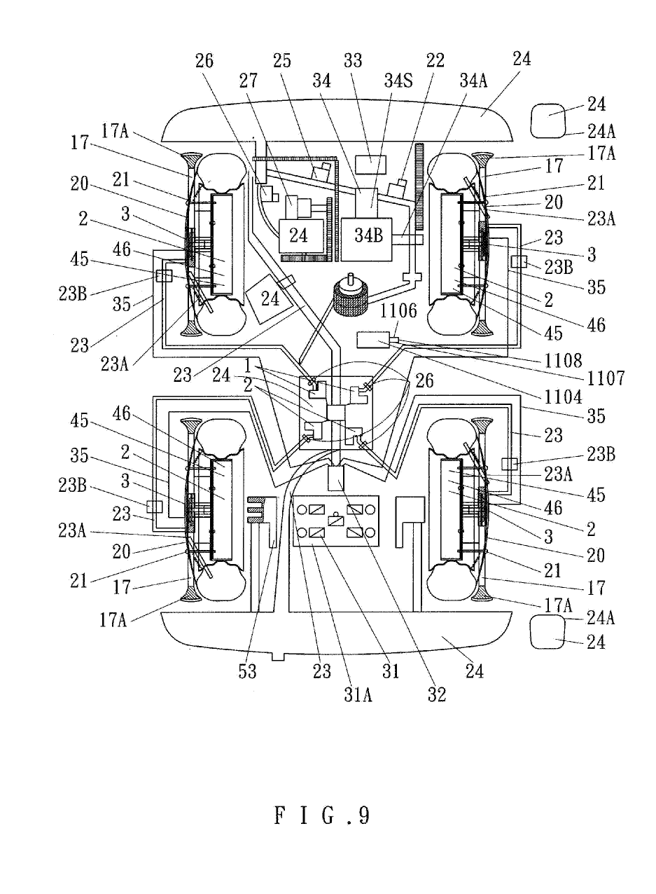

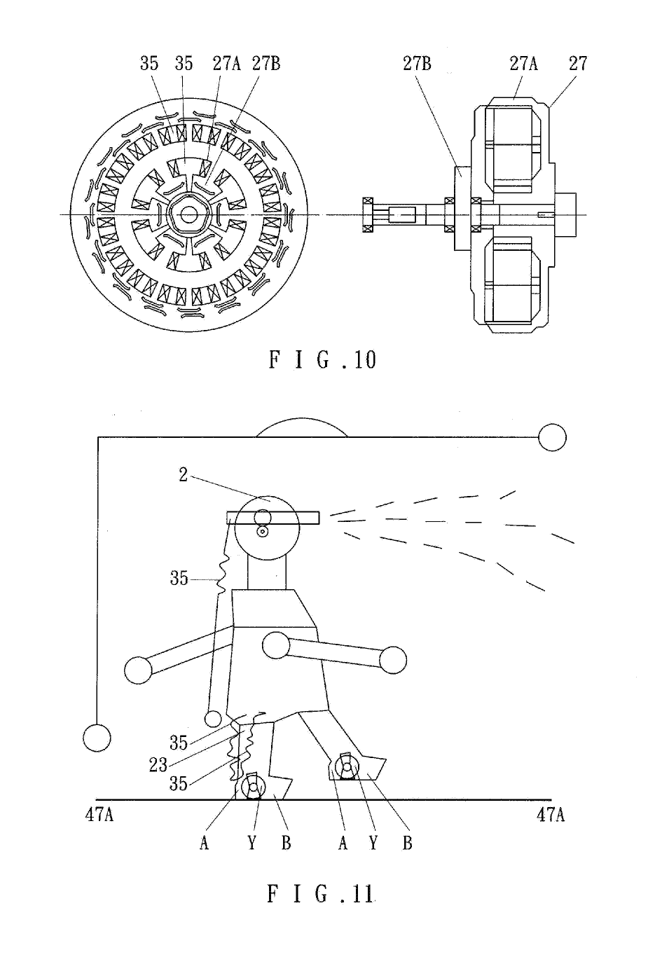

As shown from FIG. 1 to FIG. 11, this invention provides an assistant propulsion mechanism, wherein: groove (1A) is made at side edge of tire (1), screws are made around wheel rim (2) of tire (1), meanwhile, screws are also set on silicon plate of stator (7) and bolt (9) passes through wheel rim (2) and screw of silicon plate of stator (7) to tighten wheel rim (2) and silicon plate of stator (7), and copper wire (6) and magnet (10) are set on silicon plate of stator (7), insulation plate (8) is assembled around copper wire (6); axis (3) is fixed at wheel rim (2) with bolt (4) and through hole (8A) in wheel rim (2), rotor turntable (14) is covered onto axis by through hole (14A), magnet (15) on rotor turntable (14) is set opposite to magnet (10) on silicon plate of stator (7) in same pole; turntable of gear wheel (12) is connected with center of gear wheel (12B), wherein mini gear wheel (12S) is assembled at center of gear wheel (12B) so as to mesh with gear wheel (14B) of rotor turntable (14), besides, eccentric shaft (12A) is also assembled on turntable of gear wheel (12) eccentrically;

Besides, several air compressor cylinders (11) are installed on silicon plate of stator (7), which are fixed at silicon plate of stator (7) with bolts, wherein inlet tube (11A) is installed at one end of cylinder and outlet tube (11B) is at another end, meanwhile, spring (11B1), piston (11B2) and air push sheet (11E) are assembled inside said cylinder (11), board (11B3) with through hole at center is also assembled in cylinder (11), one end of piston (11B2) is connected with spring (11B1) against outlet tube (11B) via through hole of board (11B2); and another end of piston (11B2) is connected with air push sheet (11E) which is pivoted with eccentric shaft (12A) through push bar (11C);

Return wheel bar (16) passes though axis (3) of rotor turntable (14) and fixed at it by bolt (18), nut (19A) is screwed onto axis to connect wheel rim (2), rotor turntable (14) and return wheel bar (16); two sets of push bars (17) are installed oppositely to pivot with two ends of return wheel bar (16) respectively, and ends of push bar (17) have rubber (17A); one end of spring (19) is connected to middle of push bar (17) and its another end is connected with silicon plate of stator (7); if tire turns, the parts to contact ground are compressed, and push bar (17) and rubber (17A) may be pushed upward if contact ground to drive return wheel bar (16), that consequently drive rotor turntable (14), meanwhile, rotor turntable (14) and silicon plate of stator (7) produce relative turning to generate power, cylinder (11) is also inflated; if push bar does not contact ground, it will be pulled back by spring (19) for resetting; copper wire (6) is connected to charger (32) and battery (31), ammeter (33A) connected with battery (31) is to display the left volume;

Two ends of rotor turntable (14) are oppositely set cylinders (22), screw (20) is set in cylinder, and gear wheel (21) is fixed at axis (21A) of screw (20), and gear wheel (21) is meshed with gear wheel (14B) of rotor turntable (14), one end of cylinder (22) is installed with inlet tube (23A) and its another end has outlet tube (23B), both tubes are fixed at silicon plate of stator (7) by bolt, and cylinder cover (20A) is also fixed at silicon plate of stator (7) by bolt;

Barrel (1105) is installed with anti-collision device (1104) and fixed at car body (53) by bolt (A), one head of barrel (1105) has an extended tube (1108) which is connected with electromagnetic valve (1106), and electromagnetic valve (1105) is connected to switch on instrument panel through conducting wire (1107), rubber (1109) is installed beside fuel feed hole of vehicle, you only open switch to start electromagnet valve and push away rubber for refueling.

Air in cylinder (11) enter into inlet tube (23A) to inflate tire, then, air flow into outlet tube (23B) and enter into air tank (24) via air tube (23), control valve is installed between air tube (23) and air tank (24), so that said control valve could turn off if tire is flat; to cool down air tank (24) with electric control board, and air tank is connected to air gauge (33) by air tube to display pressure of air tank (24); air tube (23) and air tank (24) are connected to tube (1102) which is installed with wind wheel (1101), and wind wheel (1105) is connected to axis of motor (110) which is then connected with gear wheel (119) to drive gear wheel (118) of turntable, and gear wheel (118) is connected with axis (118D) of wind wheel (118), meanwhile, wind wheel (118B) is also installed with box (118A) and seat (118Y);

Air tube (23) is connected to electronic valve (25), thus, air entering can cool it down first, then connected to cylinder (34) of engine; bushing (S) is fixed at air tube (23) by bolt (S1); electronic valve (22) is passable to cylinder (34) of engine, air tube (23), wind tube (118A) and inlet tube (23A); fixing turntable (1103) is installed under engine and its gear wheel (117) meshes with gear wheel (116) to drive axis of seat (115), gear wheel (116) meshes with mini gear wheel (113), axis (112) is fixed at mini gear wheel (113) and mini gear wheel (111) is fixed at axis (112), mini gear wheel (111) meshes with gear wheel (29) of engine;

Gasoline throttle (37A) is connected to power-on point (36) to start motor and electronic valve; spring is assembled at back of gasoline valve (37A), so that it will no be powered if not refueled; motor (44) is switched on/off accordingly;

Steering button (37B) to control speeds of vehicle is also installed, and row teeth bar under gasoline throttle is connected to steering button (37B) to control speeds of vehicle, thus, the lower gasoline throttle is stepped, the faster the speed is, however, if step off, power is cut off.

If vehicle is not driven, circuit may inform electronic valve (25) to turn off.

Magnet installed around belt wheel of engine generates power with stator that can release rotor and save space.

Electronic valve is connected to moving sheet of the cylinder of the engine through air tube, if moving sheet is on the top, electronic valve (22) turns off and electronic valve (25) turns on, air entering into cylinder press moving sheet downward.

If moving sheet is installed beneath, electronic valve (22) turns on and electronic valve (25) turns off, air is exhausted of cylinder to enter into wind wheel through air tube to drive mini gear wheel.

Air tank (24) is the passable windbag of air power and it is also used for anti-collision.

Screw (20) runs stably without noise, return wheel bar (16) drives rotor turntable (14) to generate power and inflate tire.

Push bar (11C) moves forward/backward along with air push sheet (11E) at the same time so that vehicle wheels drive smoothly.

Two sets of push bar (17) are installed oppositely and run stably.

Circuit (43) is to turn on/off electronic valve, and circuit (44) is to control motor.

Silent sheet is installed in cylinder (11) so as to prevent air push sheet (11E) from producing noise.

All fixing connections are connected with bolts.

Push bar and switch are installed onto engine, push bar touches switch to power on as engine is running so as to push forward moving sheet to produce power.

Rotor and stator of cylinder are fixed under shoes and foot of human body, which are connected to charger for charging and inflating as human body is walking.

What is claimed is:

1. An assistant propulsion mechanism featuring in: groove (1A) is made at side edge of tire (1), screws are made around wheel rim (2) of tire (1), meanwhile, screws are also set on silicon plate of stator (7) and bolt (9) passes through wheel rim (2) and screw of silicon plate of stator (7) to tighten wheel rim (2) and silicon plate of stator (7), copper wire (6) and magnet (11) are set on silicon plate of stator (7), insulation plate (8) is assembled around copper wire (6); axis (3) is fixed at wheel rim (2) with bolt (4) and through hole (8A) in wheel rim (2), rotor turntable (14) is covered onto axis by through hole (14A), magnet (15) on rotor turntable (14) is set opposite to magnet (10) on silicon plate of stator (7) in same pole; turntable of gear wheel (12) is connected with center of gear wheel (12B), wherein mini gear wheel (12S) is assembled at center of gear wheel (12B) so as to mesh with gear wheel (14B) of rotor turntable (14), besides, eccentric shaft (12A) is also assembled on turntable of gear wheel (12) eccentrically;
Besides, several air compressor cylinders (11) are installed on silicon plate of stator (7), which are fixed at silicon plate of stator (7) with bolts, wherein inlet tube (11A) is installed at one end of cylinder and outlet tube (11B) is at another end, meanwhile, spring (11B1), piston (11B2) and air push sheet (11E) are assembled inside said cylinder (11), board (11B3) with through hole at center is also assembled in cylinder (11), one end of piston (11B2) is connected with spring (11B1) against outlet tube (11B) via through hole of board (11B2); and another end of piston (11B2) is connected with air push sheet (11E) which is pivoted with eccentric shaft (12A) through push bar (11C);
Return wheel bar (16) passes though center of rotor (3) of rotor turn table (14) and fixed at it by bolt (18), nut (19A) is screwed onto axis to connect wheel rim (2), rotor turn table (14) and return wheel bar (16); two sets of push bars (17) are installed oppositely to pivot with two ends of return wheel bar (16) respectively, and ends of push bar (17) have rubber (17A); one end of spring (19) is connected to middle of push bar (17) and its another end is connected with silicon plate of stator (7); if tire turns, the parts to contact ground are compressed, and push bar (17) and rubber (17A) may be pushed upward if contact ground to drive return wheel bar (16), that consequently drive rotor turntable (14), meanwhile, rotor turntable (14) and silicon plate of stator (7) produce relative turning to generate power, cylinder (11) is also inflated; if push bar does not contact ground, it will be pulled back by spring (19) for resetting; copper wire (6) is connected to charger (32) and battery (31), ammeter (33A) connected with battery (31) is to display the left volume;
Two ends of rotor turn table (14) are oppositely set cylinders (22), screw (20) is set in cylinder, and gear wheel (21) is fixed at axis (21A) of screw (20), and gear wheel (21) is meshed with gear wheel (14B) of rotor turn table (14), one end of cylinder (22) is installed with inlet tube (23A) and its another end has outlet tube (23B), both tubes are fixed at silicon plate of stator (7) by bolt, and cylinder cover (20A) is also fixed at silicon plate of stator (7) by bolt;
Barrel (1105) is installed with anti-collision device (1104) and fixed at vehicle body (53) by bolt (A), one head of barrel (1105) has an extended tube (1108) which is connected with electromagnetic valve (1106), and electromagnetic valve (1105) is connected to switch on instrument panel through conducting wire (1107), rubber (1109) is installed beside fuel feed hole of vehicle, you only open switch to start electromagnet valve and push away rubber for refueling.
Air in cylinder (11) enter into inlet tube (23A) to inflate tire, then, air flow into outlet tube (23B) and enter into air tank (24) via air tube (23), control valve is installed between air tube (23) and air tank (24), so that said control valve could turn off if tire is flat; to cool down air tank (24) with electric control board, and air tank is connected to air gauge (33) by air tube to display pressure of air tank (24); air tube (23) and air tank (24) are connected to tube (1102) which is installed with wind wheel (1101), and wind wheel (1105) is connected to axis of motor (110) which is then connected with gear wheel (119) so as to drive gear wheel (118) of turntable, and gear wheel (118) is connected with axis (118D) of wind wheel (118), meanwhile, wind wheel (118B) is also installed with box (118A) and seat (118Y);
Air tube (23) is connected to electronic valve (25), thus, air entering can cool it down first, then connected to cylinder (34) of engine; bushing (S) is fixed at air tube (23) by bolt (S1); electronic valve (22) is passable to cylinder (34) of engine, air tube (23), wind tube (118A) and inlet tube (23A); fixing turntable (1103) is installed under engine and its gear wheel (117) meshes with gear wheel (116) to drive axis of seat (115), gear wheel (116) meshes with mini gear wheel (113), axis (112) is fixed at mini gear wheel (113) and mini gear wheel (111) is fixed at axis (112), mini gear wheel (111) meshes with gear wheel (29) of engine;
Gasoline throttle (37A) is connected to power-on point (36) to power motor and electronic valve; spring is assembled at back of gasoline valve (37A), so that it will no be powered if not refueled; motor (44) is switched on/off accordingly;
Steering button (37B) to control speeds of vehicle is also installed, and row teeth bar under gasoline throttle is connected to steering button (37B) to control speeds of vehicle, thus, the lower gasoline throttle is stepped, the faster the speed is, however, if step off, power is cut off.
If vehicle is not driven, circuit may inform electronic valve (25) to turn off.

2. An assistant propulsion mechanism for vehicle of claim 1 wherein said groove (1A) is made at side edge of tire (1), ends of push bar (17) cooperate with groove (1A) so that push bar (17) moves up/downward to generate power and inflate tire.

3. An assistant propulsion mechanism for vehicle of claim 1 wherein said mini gear wheel (111) meshes with gear wheel (29) of engine, return wheel bar (16) drives rotor turntable (14) to produce propulsion as required.

4. An assistant propulsion mechanism for vehicle of claim 1 wherein said magnets are installed around belt wheel of engine, which generate power with support of stator that may release rotor and save space.

5. An assistant propulsion mechanism for vehicle of claim 1 wherein said electronic valve is connected to moving sheet of the cylinder of the engine through air tube, if moving sheet is on the top, electronic valve (22) turns off and electronic valve (25) turns on so that air enter into cylinder to press down moving sheet.

6. An assistant propulsion mechanism for vehicle of claim 1 wherein said electronic valve (22) turns on and electronic valve (25) turns off if said moving sheet is installed beneath, and air is exhausted of cylinder and enter into wind wheel via air tube to drive mini gear wheel.

7. An assistant propulsion mechanism for vehicle of claim 1 wherein said air tank (24) is the connecting wind tank of air propulsion, it also can be used for anti-collision.

8. An assistant propulsion mechanism for vehicle of claim 1 wherein said screw (20) runs stably without noise, said return wheel bar (16) drives rotor turntable (14) to generate power and inflate tire.

9. An assistant propulsion mechanism for vehicle of claim 1 wherein said push bar (11C) moves forward/backward along with said air push sheet (11E), so that vehicle can be driven stably.

10. An assistant propulsion mechanism for vehicle of claim 1 wherein said two push bars (17) are installed oppositely and run stably.

11. An assistant propulsion mechanism for vehicle of claim 1 wherein said magnet (48) is installed under car body (33), and magnet (47) is also laid down beside road (47A), same poles of two pieces of magnet are installed oppositely so as to exclude each other, thus, weight of vehicle is reduced relatively, vehicle may consume fewer gasoline and power.

12. An assistant propulsion mechanism for vehicle of claim 1 wherein said magnet (48) is installed under car body (33), and magnet (47) is also laid down beside road (47A), same poles of two pieces of magnet are installed oppositely so as to exclude each other, thus, weight of vehicle is reduced relatively, vehicle may consume fewer gasoline and power.

13. An assistant propulsion mechanism for vehicle of claim 1 wherein said solar cell (49) is installed on car body (53), transparent basket (50) and copper wire (55) are assembled in said solar cell, and solar cell (49) is fixed at car body (53) by bolt (52).

14. An assistant propulsion mechanism for vehicle of claim 1 wherein circuit (43) is to turn on/off electronic valve, circuit (43) is to control motor.

15. An assistant propulsion mechanism for vehicle of claim 1 wherein said cylinder (11) is equipped with silent sheet so as to prevent air push sheet (11E) from producing noise.

16. An assistant propulsion mechanism for vehicle of claim 1 wherein all fixing connections are connected by bolts.

17. An assistant propulsion mechanism for vehicle of claim 1 wherein said engine is equipped with push bar and switch so that push bar can contact switch to switch on power as engine is running, moving sheet is pushed to produce propulsion.

18. An assistant propulsion mechanism for vehicle of claim 1 wherein said rotor and stator of cylinder are fixed under shoes and foot of human body and connected to charger by conducting wire so as to generate power and inflate tire as human body is walking.
